(19) United States
(12) Patent Application Publication
(10) Pub. No.: US 2011/0154501 A1
(43) Pub. Date: Jun. 23, 2011

(54) HARDWARE ATTESTATION TECHNIQUES

(76) Inventors: Rajesh P. Banginwar, Hillsboro, OR (US); Taeho Kgil, Beaverton, OR (US)

(21) Appl. No.: 12/646,582

(22) Filed: Dec. 23, 2009

(51) Int. Cl. G06F 21/22

(52) U.S. Cl. 726/26

(57) ABSTRACT

Hardware attestation techniques are described. An apparatus may comprise a platform comprising a processor capable of operating in an isolated execution mode and persistent storage having entity information associated with an entity having control of a software application. The platform may include a security controller communicatively coupled to the platform, the security controller having a signature generator operative to generate a platform signature for the software application executing on the platform, the platform signature comprising a cryptographic hash of entity information, and an attest module operative to provide the platform signature to the software application with the platform signature to attest that that the platform is associated with the software application. Other embodiments are described and claimed.

### BACKGROUND

Hardware components for an electronic device, such as a computing platform for a computer or mobile device, are rapidly becoming commodities. In an attempt to differentiate products and services, business entities are increasingly customizing applications, services and features offered by software products to provide unique device experiences for end users. For instance, an original equipment manufacturer (OEM) may manufacture devices made with hardware purchased from one company, software purchased from another company, and specialized software provided by the OEM as a value added service. As such, for many business entities software products have become a primary asset for a given class or family of devices.

Unscrupulous attackers attempt to take advantage of this product or service differentiator by creating unauthorized devices with a successful software product. This may occur by cloning a device using commoditized hardware and unauthorized software images. This may also occur by physically replacing chipsets of an existing device and using an authorized software product with unauthorized hardware. Such attacks may be hampered or defeated by associating or binding a software product to a hardware platform, and vice-versa. It is with respect to these and other considerations that the present improvements are needed.

### BRIEF DESCRIPTION OF THE DRAWINGS

FIG. 1 illustrates one embodiment of a platform.

FIG. 2 illustrates one embodiment of a first logic flow.

FIG. 3 illustrates one embodiment of a second logic flow.

FIG. 4 illustrates one embodiment of an operating embodiment.

FIG. 5 illustrates one embodiment of a system.

### DETAILED DESCRIPTION

Various embodiments may be generally directed to hardware attestation techniques. Some embodiment may be particularly directed to hardware attestation techniques to attest or authenticate a given hardware platform for use with a particular software product. In this manner, a hardware platform and a software product may be associated with each other so that a software product may only execute on an authorized hardware platform.

In one embodiment, for example, an apparatus such as an electronic device may include a computing platform having a processor capable of operating in an isolated execution mode and persistent storage. The persistent storage may store entity information associated with an entity having control of a software application, such as an OEM or operating system vendor (OSV), for example. A security controller may be communicatively coupled to the platform. The security controller may include a signature generator operative to generate a platform signature for the software application executing on the platform. The platform signature may comprise a cryptographic hash of entity information. The security controller may also include an attest module operative to provide the platform signature to the software application, with the platform signature to attest that that the platform is associated with the software application. Other embodiments are described and claimed.

The use of a platform signature to create a binding between a hardware platform and a software product may provide several advantages. For instance, no other hardware platform may be cloned or substituted for use with a software product or a copy of the software product. In another example, selectable features for a software product may be implemented for different hardware platforms, and vice-versa. These and other advantages may result in enhanced security and control for software products and associated hardware platforms.

In the following description, terminology is used to discuss certain features of the present invention. For example, a “platform” includes hardware equipment and/or software that perform different functions on stored information. Examples of a platform include, but are not limited or restricted to a computer (e.g., desktop, a laptop, a hand-held, a server, a workstation, etc.), desktop office equipment (e.g., printer, scanner, a facsimile machine, etc.), a wireless telephone handset, a television set-top box, and the like. A “software product” or “software application” or “software module” includes code that, when executed, performs a certain function. A “nub” is a series of code instructions, possibly a subset of code from a software module. A “link” is broadly defined as one or more information-carrying mediums (e.g., electrical wire, optical fiber, cable, bus, or wireless signaling technology).

In addition, the term “information” is defined as one or more bits of data, address, and/or control. A “segment” is one or more bytes of information. A “page” is a predetermined number of bytes, usually a power of two in length (e.g., 512, 1024, etc.). A “cryptographic hash algorithm” is an algorithm or function, mathematical or otherwise, that converts information from a variable length to a fixed length, sometimes referred to as a “hash value” or “message digest” or simply “digest.” A “one-way cryptographic hash algorithm” indicates that there does not readily exist an inverse function to recover any discernible portion of the original information from the fixed-length hash value. Examples of a cryptographic hash algorithm include a Secure Hash Algorithm (SHA) designed by the National Security Agency and published by the National Institute of Standards and Technology (NIST) as a United States Federal Information Processing Standard, such as the SHA-1, SHA-224, SHA-256, SHA-384 and SHA-512 as specified in a 2008 publication Secure Hash Standard FIPS 180-3 entitled “Federal Information Processing Standards Publication 180-3” (October 2008), among others.

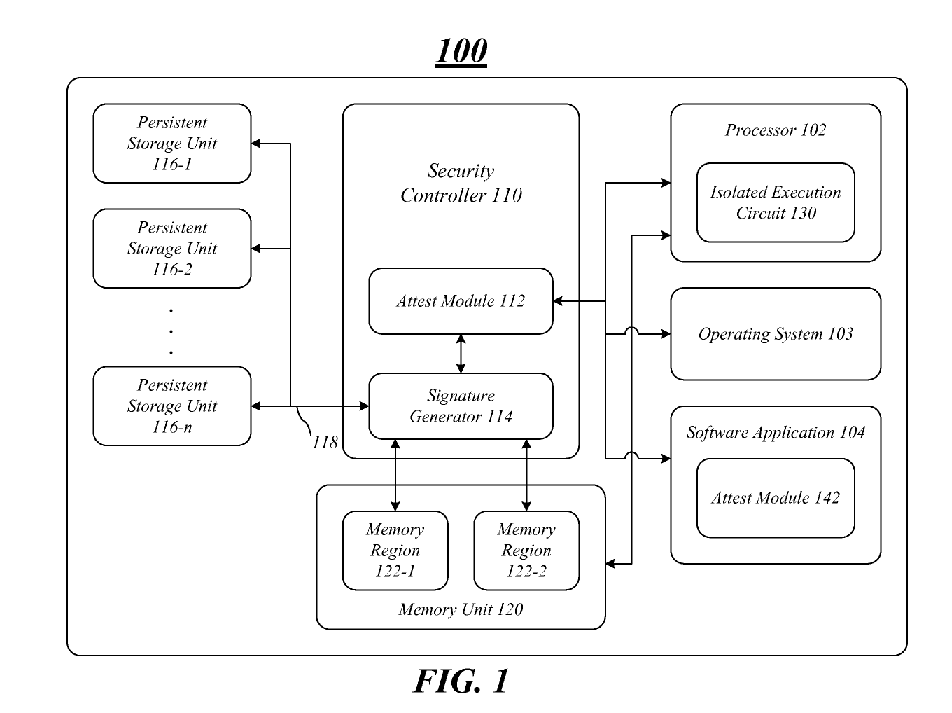

FIG. 1 illustrates an exemplary platform 100 that may be used to implement various hardware attestation techniques. The platform 100 may comprise, for example, a computing platform or a communications platform. The hardware attestation techniques may be used for authenticating that the platform 100 is authorized to execute a software product controlled by an entity, such as an OEM or OSV or other software manufacturer.

As shown in FIG. 1, the platform 100 may include various elements. In the illustrated embodiment shown in FIG. 1, for example, the platform 100 may include a processor 102, an operating system 103, a software application 104, a security controller 110, one or more persistent storage units 116-1-n, and one or more memory units 120-1-p. The security controller 110 may further include an attest module 112 and a signature generator 114. The one or more memory units 120-1-p may be separated into various memory regions 122-1-r. The various elements may be implemented as separate devices connected by various interconnect topologies with corresponding interfaces. Additionally or alternatively, some or all of the elements may be integrated on a single integrated circuit (IC), semiconductor die, or chip using a system on a chip (SoC) architecture. The embodiments are not limited in this context.

Although FIG. 1 illustrates certain elements in given topology, it may be appreciated that more or less elements in a different topology may be implemented using the techniques described herein and still fall within the scope of the embodiments. For instance, the platform 100 may be in communication with peripheral components such as a mass storage device, one or more input/output (I/O) devices, and various secure and unsecure communication buses and associated controllers. For clarity, the specific links for these peripheral components (e.g., Peripheral Component Interconnect “PCI”, accelerated graphics port “AGP”, Industry Standard Architecture “ISA”, Universal Serial Bus “USB”, etc.) are not shown. The embodiments are not limited in this context.

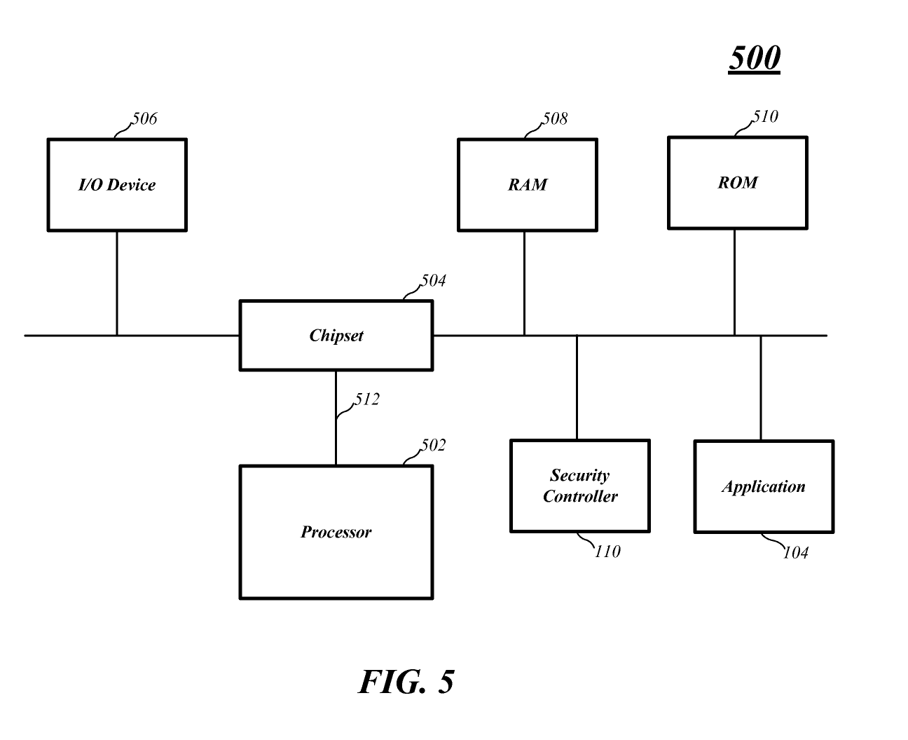

In certain embodiments, the elements of platform 100 may be implemented within, or as part of, any given electronic device. Examples of suitable electronic devices may include without limitation a mobile station, portable computing device with a self-contained power source (e.g., battery), a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communications device, computer, personal computer, server, workstation, network appliance, electronic gaming system, navigation system, map system, location system, and so forth. In some embodiments, an electronic device may comprise multiple components. In this case, the platform 100 may be implemented as part of any one of the multiple components (e.g., a remote control for a game console). In one embodiment, for example, the platform 100 may be implemented as part of a computing platform for a computing device, examples of which are described with reference to FIG. 5. In further embodiments, however, implementations may involve external software and/or external hardware. The embodiments are not limited in this context.

The platform 100 may include the processor 102. The processor 102 may have one or more processor cores. The processor 102 represents a central processing unit of any type of architecture, such as complex instruction set computers (CISC), reduced instruction set computers (RISC), very long instruction word (VLIW), or hybrid architecture. In one embodiment, the processor 102 is compatible with the Intel Architecture (IA) processor, such as the IA-32 and the IA-64. The processor 102 may comprise a general purpose processor or a special purpose processer arranged to execute various types of applications as represented by the software application 104.

The processor 102 includes an isolated execution circuit 130. The isolated execution circuit 130 provides a mechanism to allow the processor 102 and/or the platform 100 to operate in an isolated execution mode. The isolated execution circuit 130 provides hardware and software support for the isolated execution mode. This support includes configuration for isolated execution, definition of the isolated area, definition (e.g., decoding and execution) of isolated instructions, generation of isolated access bus cycles, and generation of isolated mode interrupts. In one embodiment, for example, the isolated execution circuit 130 may be arranged to implement an isolated architecture (ISOX™) architecture. The embodiments are not limited in this context.

The platform 100 may include one or more software applications 104. The software application 104 may comprise any application program stored and executed by the processor 102. Furthermore, the software application 104 may have embedded security features to access documents, features or services provided by the platform 100. As such, the software application 104 may serve as a client for security services provided by the security controller 110. The software application 104 may also access and/or control some of the security services managed by the security controller 110, such as when the processor 102 is operating in an isolated execution mode, in order to authenticate the platform 100. For instance, the software application 104 may have access to the processor 102, the security controller 110, the persistent storage units 116-1-n, the system memory 120, the isolated execution circuit 130, and so forth. The software application 104 may comprise a local application residing on a computing device, or a remote application residing on a remote device (e.g., a web server). In one embodiment, for example, the software application 104 may be implemented as software for an entity such as an OEM, OSV, or any other entity providing a software application suitable for execution by the platform 100.

The platform 100 may include one or more persistent storage units 116-1-n arranged to securely store information. In various embodiments, the persistent storage units 116-1-n comprise hardware storage elements that may implement programmable internal electrical fuses to allow dynamic real-time reprogramming of hardware elements, such as a semiconductor device or integrated circuit (IC), also known as a microcircuit, microchip, silicon chip, chip set, or simply chip. In one embodiment, for example, the persistent storage units 116-1-n may be implemented using internal fuse technology, such as eFUSE technology made by IBM® Corporation, Armonk, N.Y., amone others. Any known type of persistent storage unit may be implemented for the persistent storage units 116-1-n, however, and the embodiments are not limited in this context.

The platform 100 may include the security controller 110. The security controller 110 may be communicatively coupled to the one or more persistent storage units 116-1-n. The security controller 110 may be generally operative to control security for the platform 100, and may implement any number of known security and encryption techniques. In one embodiment, for example, the security controller 110 may provide various software and hardware features needed to enable a secure and robust computing platform. For example, the security controller 110 may provide various security components and capabilities such as secure boot, secure execution environments, secure storage, hardware cryptographic acceleration for various security algorithms and encryption schemes (e.g., Advanced Encryption Standard, Data Encryption Standard (DES), Triple DES, etc.), Public Key Infrastructure (PKI) engine supporting RSA and Elliptical Curve Cryptography (ECC), hashing engines for Secure Hash Function (SHA) algorithms (e.g., SHA-1, SHA-2, SHA-3, etc.), Federal Information Processing Standards (FIPS) compliant Random Number Generation (RNG), Digital Rights Management (DRM), secure debug through Joint Test Action Group (JTAG), additional security timers and counters, and so forth. In some embodiments, the security controller 110 may comprise a hardware security controller, such as an Intel® Active Management Technology (AMT) device made by Intel Corporation, Santa Clara, Calif. In other embodiments, the security controller 110 may be a hardware security controller related to the Broadcom® DASH (Desktop and Mobile Architecture for System Hardware) web services-based management technology. In yet other embodiments, the security controller 110 may be implemented by other types of security management technology. The embodiments are not limited in this context.

It is worthy to note that although the security controller 110 is shown in FIG. 1 as implemented by a separate device from the processor 102, such as another processor or controller, it may be appreciated that the features and services provided by the security controller 110 may be implemented in another component of the platform 100 or another component of an electronic device implementing the platform 100. For instance, the security controller 110 may be integrated with an Input/Output (I/O) controller, an I/O control hub (ICH) or the processor 102 of the platform 100. In the latter case, for example, the security controller 110 may be implemented as part of the isolated execution circuit 130 of the processor 102. The embodiments are not limited in this context.

The platform 100 may also include one or more memory units 120-1-p with multiple memory regions 122-1-r. The embodiment illustrated in FIG. 1 shows a single memory unit 120 having two memory regions 122-1, 122-2. Each of the memory regions 122-1-r may be defined for different levels of security access and priority levels. In one embodiment, for example, the first memory region 122-1 may comprise an isolated memory region that is defined by the processor 102 when operating in the isolated execution mode. The second memory region 122-2 may comprise a shared memory region. Although a single memory unit 120 with multiple memory regions 122-1, 122-2 is shown in FIG. 1, it may be appreciated that multiple memory units 120-1, 120-2 may be implemented for the platform 100, with each memory unit 120-1, 120-2 having a respective memory region 122-1, 122-2. The embodiments are not limited in this context.

The first memory region 122-1 may comprise an isolated memory region that is defined by the processor 102 when operating in the isolated execution mode. One concept of an isolated execution architecture such as ISOX is the creation of a region in system memory protected by the processor and/or chipset in the platform 100. This region of protected memory is referred to as an “isolated area,” such as isolated memory region 122-1 of the memory unit 120. Access to the isolated memory region 122-1 is permitted using special memory read and write cycles, which are referred to as “isolated read and write” cycles. The isolated read and write cycles are issued by the processor 102 operating in the isolated execution mode. Access to the isolated memory region 122-1 is restricted and is enforced by the processor 102 and/or the security controller 110 or other chipset that integrates the isolated area functionalities. In general, the isolated memory region 122-1 is accessible by only the security controller 110 and the processor 102 when operating in an isolated execution mode. In some embodiments, some or all of the software application 104 may be authorized to execute on the processor 102 when operating in an isolated execution mode. For instance, the attest module 142 may be so authorized in order to authenticate the platform 100 for use with the software application 104.

The second memory region 122-2 may comprise a shared memory region. The shared memory region 122-2 is a normal or unprotected region of memory used by all of the components of platform 100 when the platform 100 is operating in a normal execution mode.

In various embodiments, the security controller 110 may include the attest module 112. The attest module 112 may be generally arranged to detect and verify whether the software application 104 is authorized to execute on the platform 100. The attest module 112 may be a security sub-system of the security controller 110. In various embodiments, the attest module 112 may be implemented with various hardware and software structures suitable for a security sub-system, such as one or more embedded security processors, interrupt controller, instruction cache, data cache, memory, cryptographic acceleration engines, hardware based RNG, secure JTAG, and other elements.

In various embodiments, the security controller 110 may include a signature generator 114. The signature generator 114 may be arranged to generate information confirming an identity for the platform 100. In one embodiment, for example, the signature generator 114 may generate a platform signature to identify authenticity of the platform 100.

In general operation, the isolated execution circuit 130 may place the processor 102 and/or the platform 100 in isolated execution mode. In one embodiment, for example, the isolated execution circuit 130 may implement an ISOX architecture. The ISOX architecture includes logical and physical definitions of hardware and software components that interact directly or indirectly with an operating system 103 of the platform 100. Herein, the processor 102 and the operating system 103 of the platform 100 may have several levels of hierarchy, referred to as rings, which correspond to various operational modes. A “ring” is a logical division of hardware and software components that are designed to perform dedicated tasks within the operating system. The division is typically based on the degree or level of privilege, namely the ability to make changes to the platform. For example, a ring-0 is the innermost ring, being at the highest level of the hierarchy. Ring-0 encompasses the most critical, privileged components. Ring-3 is the outermost ring, being at the lowest level of the hierarchy. Ring-3 typically encompasses user level applications, which are normally given the lowest level of privilege. Ring-1 and ring-2 represent the intermediate rings with decreasing levels of privilege.

The platform 100 has at least two modes of operation, including a normal execution mode and isolated execution mode. Ring-0 includes two portions, a normal execution Ring-0 and an isolated execution Ring-0. The normal execution Ring-0 includes software modules that are critical for the operating system. Typically, these software modules include a primary operating system referred to as the “kernel” (e.g., the unprotected segments of the operating system), software drivers, and hardware drivers. Similarly, ring-1, ring-2, and ring-3 include normal execution and isolated execution portions.

The isolated execution Ring-0 includes an operating system (OS) nub and a processor nub. The OS nub and the processor nub are instances of an OS executive (OSE) and processor executive (PE), respectively. The OSE and the PE are part of executive entities that operate in a secure environment associated with the isolated areas and the isolated execution mode.

The OS nub provides links to services in the primary operating system, provides page management within the isolated area, and has the responsibility for loading some ring-0 software modules as well as ring-3 software modules into protected pages allocated in the isolated area. The OS nub may also support encrypting and hashing the isolated area pages before evicting the page(s) to the shared (unprotected) memory region 122-2, and/or checking the page contents upon restoration of the page.

The processor nub provides the initial set-up and low-level management of the isolated memory region 122-1 of the memory unit 120, including verification, loading, and logging of the OS nub, and the management of the symmetric key used to protect the operating system nub's secrets. The processor nub may also provide application programming interface (API) abstractions to low-level security services provided by other hardware. The processor nub may also be distributed by the OEM or OSV via a boot disk. The processor nub may be loaded by a processor nub loader, which is a protected bootstrap loader code held within the chipset itself and is responsible for loading the processor nub from the processor 102 or chipset into a region of isolated memory region 122-1. For instance, the processor nub loader verifies and loads a ring-0 nub software module (e.g., processor nub) into the isolated area. The processor nub provides the basic hardware-related services to support isolated execution. For example, one task of the processor nub is to verify and load the ring-0 OS nub into the isolated memory region 122-1.

The attest module 112 of the security controller 110 may be arranged to manage authentication operations for the platform 100, including sending control directives to the signature generator 114 to generate a platform signature for the software application 104 executing on the platform 100. The attest module 112 may receive the platform signature from the signature generator 114, and provide the platform signature to the software application 104. The attest module 142 of the software application 104 may use the platform signature to attest that that the platform 100 is associated with the software application 104.

In one embodiment, the platform signature may comprise a cryptographic hash of entity information associated with an entity having control of the software application 104, such as an OEM or OSV, among other entities. An entity may store entity information in one or more of the persistent storage units 116-1-n for the platform 100 sometime prior to the signature generator 114 generating a platform signature. In this manner, the signature generator 114 may generate a platform signature using the entity information as a security mechanism for identifying the platform 100. An entity such as an OEM or OSV normally provisions a proprietary software application, such as the application 104, on the platform 100 during manufacturing and assembly. During provisioning, the OEM or OSV may store entity information specific to the OEM or OSV in one or more of the persistent storage units 116-1-n. For instance, an entity may store cryptographic entity information, such as access codes, ciphers, symmetric or asymmetric security keys, hash values, and any other cryptographic information. The entity may store non-cryptographic entity information, such as an entity name, an entity identifier, a globally unique identifier, entity identification information, vendor identification number, tracking numbers, stock keeping unit (SKU), and any other non-cryptographic entity information. The embodiments are not limited to any specific entity information, as long as the entity information is provided by the entity. The persistent storage units 116-1-n are designed to provide sufficient cryptographic properties or attributes that make it difficult or impossible to read through hardware attacks. Therefore a third party is hampered or prevented from stealing information stored in the persistent storage units 116-1-n.

In one embodiment, the persistent storage units 116-1-n may store entity information in the form of one or more asymmetric security keys for the entity. Asymmetric key algorithms are used to create a mathematically related key pair, including a secret private key and a published public key. Use of these keys allows protection of the authenticity of a message by creating a digital signature of a message using the private key, which can be verified using the public key. It also allows protection of the confidentiality and integrity of a message, by public key encryption, encrypting the message using the public key, which can only be decrypted using the private key. An entity may store one or more asymmetric security keys, such as one or more public keys, in one or more persistent storage units 116-1-n.

In one embodiment, the persistent storage units 116-1-n may store entity information in the form of one or more cryptographic hashes of different asymmetric security keys for the entity. Cryptographic hash algorithms are a class of deterministic procedures that take an arbitrary block of data and return a fixed-size bit string, the (cryptographic) hash value, such that an accidental or intentional change to the data will change the hash value. The data to be encoded is often called the “message,” and the hash value is sometimes called the “message digest” or simply “digest.” An entity may store one or more asymmetric security keys, such as one or more public keys, in one or more persistent storage units 116-1-n as cryptographic hashes of different public keys. In one embodiment, for example, the persistent storage units 116-1-n may store one or more SHA-256 hashes corresponding to different public keys used by an entity.

In one embodiment, the persistent storage units 116-1-n may store entity information in the form of one or more symmetric security keys for the entity. Symmetric-key algorithms are a class of algorithms for cryptography that use trivially related, often identical, cryptographic keys for both decryption and encryption. The encryption key is trivially related to the decryption key, in that they may be identical or there is a simple transformation to go between the two keys. The keys, in practice, represent a shared secret between two or more parties that can be used to maintain a private information link. Other terms for symmetric-key encryption are secret-key, single-key, shared-key, one-key, and private-key encryption. In one embodiment, for example, an entity may store one or more symmetric security keys in one or more persistent storage units 116-1-n.

In one embodiment, the persistent storage units 116-1-n may store entity information in the form of one or more cryptographic hashes of different symmetric security keys for the entity. In one embodiment, for example, the persistent storage units 116-1-n may store one or more SHA-256 hashes corresponding to different symmetric keys.

During authentication operations, the attest module 112 may send a control directive to the signature generator 114 to begin generating a platform signature. The signature generator 114 may generate the platform signature using entity information stored in the persistent storage units 116-1-n. In one embodiment, for example, the signature generator 114 may retrieve entity information from an appropriate persistent storage unit 116-1-n. Depending on a length for the entity information and a particular cryptographic hash algorithm, the signature generator 114 may generate the platform signature by compressing the entity information from a larger fixed length to a shorter fixed length using a cryptographic hash algorithm to produce a cryptographic hash. Additionally or alternatively, the signature generator 114 may generate the platform signature by compressing the entity information from a variable length to a fixed length using a cryptographic hash algorithm to produce a cryptographic hash. The signature generator 114 may output the platform signature to the attest module 112. The attest module 112 of the security controller 110 may then interoperate with the attest module 142 of the software application 104 to authenticate the platform 100 prior to executing other portions of the software application 104, as described in more detail below.

The signature generator 114 may generate a platform signature for the platform 100 at different times. In one embodiment, the signature generator 114 may generate a platform signature under control of the attest module 112 in real-time in response to an explicit request, such as from the attest module 142 of the software application 104. For example, the signature generator 114 may generate a platform signature in response to an initial attest request received from the attest module 112 (or attest module 142) when the platform 100 initially receives power during start-up or boot operations. Additionally or alternatively, the signature generator 114 may generate a platform signature in response to a recurring attest request received on a periodic, aperiodic or on-demand basis. The latter authentication timing may be desirable, for example, to detect tampering with the platform 100 during run-time.

In one embodiment, for example, the signature generator 114 may generate a platform signature under control of the attest module 112 prior to receiving an explicit request, and store the platform signature in the isolated memory region 122-1. Although not as secure as a real-time implementation, in some cases the security mechanism provided by the isolated execution mode of the platform 100 may provide sufficient security to perform authentication operations for the software application 104 using a pre-generated platform signature. This may be useful to support authentication checks for the software application 104 when boot times are relatively short, such as for “instant-on” boot techniques or switching between different power consumption modes, for example.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

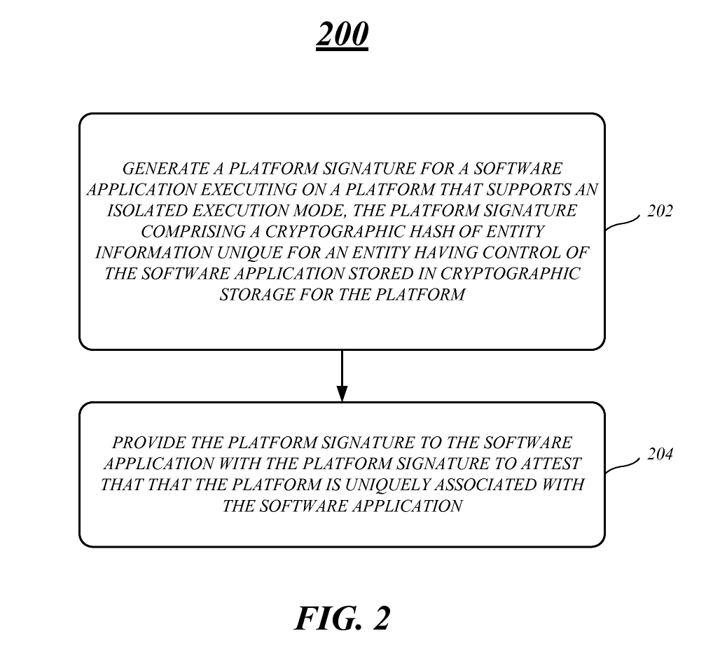

FIG. 2 illustrates one embodiment of a logic flow 200. The logic flow 200 may be representative of some or all of the operations executed by one or more embodiments described herein. For example, the logic flow 200 may be implemented by the security controller 110 of the platform 100.

In the illustrated embodiment shown in FIG. 2, the logic flow 200 may generate a platform signature for a software application executing on a platform that supports an isolated execution mode, the platform signature comprising a cryptographic hash of entity information associated with an entity having control of the software application stored in persistent storage for the platform at block 202. For instance, the signature generator 114 of the security controller 110 may generate a platform signature for the software application 104 executing on the platform 100 when the processor 102 is operating in an isolated execution mode via the isolated execution circuit 130. The platform signature may comprise a cryptographic hash of entity information associated with an entity having control of the software application 104, such as a SHA-256 hash of a public key stored in a persistent storage unit 116-1-n for the platform 100. In one embodiment, for example, the signature generator 114 may generate a platform signature in real-time in response to an explicit request, such as from the attest module 142 of the software application 104. The embodiments are not limited in this context.

The logic flow 200 may provide the platform signature to the software application with the platform signature to attest that that the platform is associated with the software application at block 204. For example, the attest module 112 may provide the platform signature to the software application 104. The attest module 142 of the software application 104 may use the platform signature to attest that the platform 100 is associated with the software application 104, and therefore some or all of the services and features provided by the software application 104 may be executed by the processor 102 of the platform 100. The embodiments are not limited in this context.

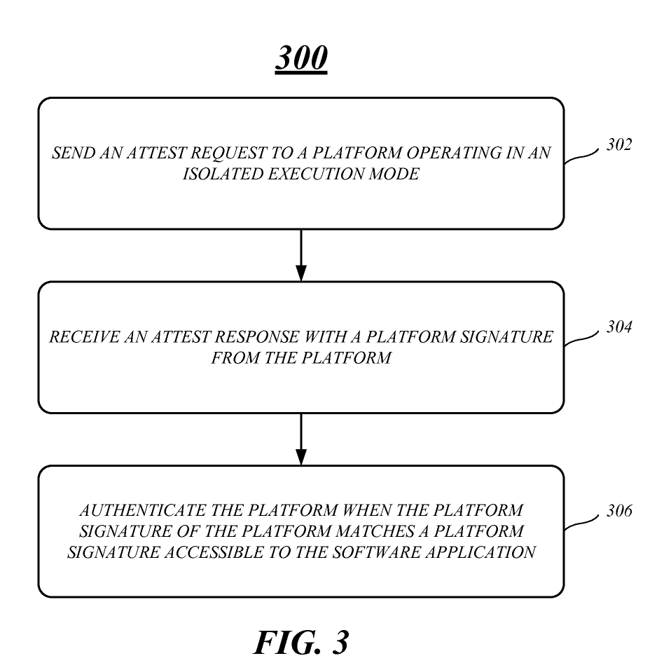

FIG. 3 illustrates one embodiment of a logic flow 300. The logic flow 300 may be representative of some or all of the operations executed by one or more embodiments described herein. For example, the logic flow 300 may be implemented by the software application 104.

In the illustrated embodiment shown in FIG. 3, the logic flow 300 may send an attest request to a platform operating in an isolated execution mode at block 302. For example, the attest module 142 of the software application 104 may send an attest request to the attest module 112 of the security controller 110 when the platform 100 is operating in an isolated execution mode via the isolated execution circuit 130. The attest module 142 may send an attest request during boot operations when the platform 100 initially receives power or resumes from a different power consumption mode. Additionally or alternatively, the attest module 142 may send an attest request on a periodic, aperiodic or on-demand basis during execution of the software application 104 on the platform 100 as additional security checks. The embodiments are not limited in this context.

The logic flow 300 may receive an attest response with a platform signature from the platform at block 304. For example, the attest module 142 may receive an attest response with a platform signature from the attest module 112 of the security controller 110 when the platform 100 is operating in an isolated execution mode via the isolated execution circuit 130. The embodiments are not limited in this context.

The logic flow 300 may authenticate the platform when the platform signature of the platform matches a platform signature accessible to the software application at block 306. For example, the attest module 142 may authenticate the platform 100 when the platform signature of the platform 100 matches a platform signature accessible to the software application 104. For example, the attest module 142 may authenticate the platform 100 when the platform signature of the platform 100 matches a platform signature accessible to the software application 104. The platform signature accessible to the software application 104 may be stored as part of the attest module 142, or may be generated using the same cryptographic technique used to generate the platform signature received from the platform 100. For example, assume the platform 100 returns a platform signature as a cryptographic hash as a bit string “2fd4e1c6 7a2d28fc ed849ee1 bb76e739 1b93eb12.” The attest module 142 may compare the received platform signature “2fd4e1c6 7a2d28fc ed849ee1 bb76e739 1b93eb12” with a stored bit string “2fd4e1c6 7a2d28fc ed849ee1 bb76e739 1b93eb12,” and if there is a match, then the platform 100 is authenticated, otherwise execution of the software application 104 stops. Alternatively, the attest module 142 may compare the received platform signature “2fd4e1c6 7a2d28fc ed849ee1 bb76e739 1b93eb12” with a calculated bit string “2fd4e1c6 7a2d28fc ed849ee1 bb76e739 1b93eb12” calculated by the attest module 142 using the same cryptographic hash algorithm and entity information as the signature generator 114, and if there is a match, then the platform 100 is authenticated, otherwise execution of the software application 104 stops. The embodiments are not limited in this context.

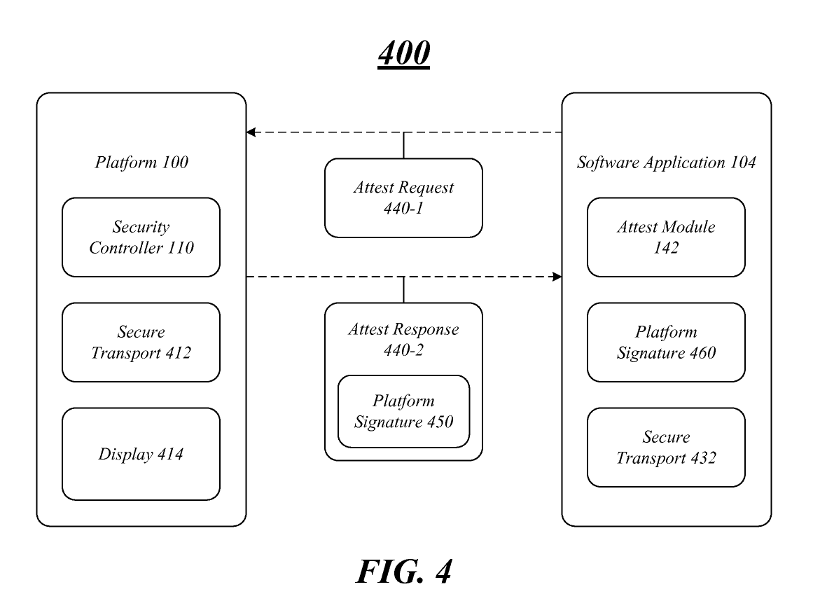

FIG. 4 illustrates one embodiment of an operating embodiment 400. The operating embodiment 400 may illustrate a message flow between the platform 100 and the software application 104 for attestation or authentication operations of the platform 100.

In the illustrated embodiment shown in FIG. 4, the attest module 142 of the software application 104 may send an attest request 440-1 to the attest module 112 of the security controller 110 when the platform 100 is operating in an isolated execution mode via the isolated execution circuit 130.

The attest module 112 may receive the attest request 440-1, and send a control directive to the signature generator 114 to generate a platform signature 450. The signature generator 114 may generate the platform signature 450 in real-time in response to the attest request 440-1 received from the attest module 142, thereby enhancing security for attestation operations. For example, the signature generator 114 may generate the platform signature 450 using entity information stored in a persistent storage unit 116-1-n and a SHA cryptographic hash algorithm, such as SHA-256, for example. The signature generator 114 may output the platform signature 450, in the form of a SHA-256 hash value, to the attest module 112. The attest module 112 may send an attest response 440-2 with the platform signature 450 to the attest module 142.

The attest module 142 may receive the attest response 440-2 with the platform signature 450 from the attest module 112 of the security controller 110, and attempt to authenticate the platform 100 using the platform signature 450. For example, the attest module 142 may authenticate the platform 100 when the platform signature 450 of the platform 100 matches a platform signature 460 accessible to the software application 104. The platform signature 460 may be stored as part of the attest module 142, either as part of program instructions for the attest module 142 (e.g., hard-coded), stored in the isolated memory region 220-1, or some other secure storage available to the software application 104. The platform signature 460 may also be generated in real-time using the same cryptographic technique used to generate the platform signature received from the platform 100. For example, assume the platform signature 450 is a SHA-256 hash value using the SHA-256 cryptographic hash algorithm. The attest module 142 may implement a signature generator similar to the signature generator 114, and generate a SHA-256 hash value using the SHA-256 cryptographic hash algorithm and a same set of entity information. The same set of entity information may be stored as part of the attest module 142, either as part of program instructions for the attest module 142 (e.g., hard-coded), stored in the isolated memory region 220-1, stored in the persistent storage units 116-1-n, remote or off-device storage (e.g., a network server), or some other secure storage available to the software application 104. When there is a match between the platform signatures 450, 460, then the platform 100 is authenticated, otherwise execution of the software application 104 stops.

In various embodiments, the platform 100 and the software application 104 may communicate the attest request 440-1, attest response 440-2, and the platform signature 460, in a secure manner using the secure transports 412, 432. In one embodiment, for example, the secure transports 412, 432 may implement a token system using a token bus and token reader. In this case, the secure transports 412, 432 may comprise token bus interfaces to provide a signaling interface with the token bus and the token reader. The token bus provides an interface between the security controller 110 and one or more tokens in the system. A “token” is a device that performs dedicated I/O functions with security. The token may be stationary (e.g., a motherboard token) or portable to be coupled via the token reader. The token bus interface couples the token bus to the security controller 110 and ensures that when commanded to prove the state of the isolated execution, the corresponding token signs only valid isolated hash values.

FIG. 5 is a diagram of a computing platform for a computing device 500. The computing device 500 may be representative of, for example, a computing device implementing the platform 100. As such, the computing device 500 may include various elements of the platform 100 and/or the operating embodiment 400. For instance, FIG. 5 shows that computing device 500 may include a processor 502, a chipset 504, an input/output (I/O) device 506, a random access memory (RAM) (such as dynamic RAM (DRAM)) 508, and a read only memory (ROM) 510, the security controller 110, and the sensors 122-1-m. The computing device 500 may also include various platform components typically found in a computing or communications device. These elements may be implemented in hardware, software, firmware, or any combination thereof. The embodiments, however, are not limited to these elements.

As shown in FIG. 5, I/O device 506, RAM 508, and ROM 510 are coupled to processor 502 by way of chipset 504. Chipset 504 may be coupled to processor 502 by a bus 512. Accordingly, bus 512 may include multiple lines.

Processor 502 may be a central processing unit comprising one or more processor cores. The processor 502 may include any type of processing unit, such as, for example, a central processing unit (CPU), multi-processing unit, a reduced instruction set computer (RISC), a processor that have a pipeline, a complex instruction set computer (CISC), digital signal processor (DSP), and so forth. The processor 502 may be representative of, for example, the processor 102 having the isolated execution circuit 130.

Although not shown, the computing device 500 may include various interface circuits, such as an Ethernet interface and/or a Universal Serial Bus (USB) interface, and/or the like. In some exemplary embodiments, the I/O device 506 may comprise one or more input devices connected to interface circuits for entering data and commands into the computing device 500. For example, the input devices may include a keyboard, mouse, touch screen, track pad, track ball, isopoint, a voice recognition system, and/or the like. Similarly, the I/O device 506 may comprise one or more output devices connected to the interface circuits for outputting information to an operator. For example, the output devices may include one or more displays, printers, speakers, LEDs, vibrators and/or other output devices, if desired. For example, one of the output devices may be a display. The display may be a cathode ray tube (CRTs), liquid crystal displays (LCDs), or any other type of electronic display, such as display 414 shown in FIG. 4.

The computing device 500 may also have a wired or wireless network interface to exchange data with other devices via a connection to a network. The network connection may be any type of network connection, such as an Ethernet connection, digital subscriber line (DSL), telephone line, coaxial cable, etc. The network (220) may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a storage medium, a computer-readable medium or an article of manufacture which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It should be understood that embodiments may be used in a variety of applications. Although the embodiments are not limited in this respect, certain embodiments may be used in conjunction with many computing devices, such as a personal computer, a desktop computer, a mobile computer, a laptop computer, a notebook computer, a tablet computer, a server computer, a network, a Personal Digital Assistant (PDA) device, a wireless communication station, a wireless communication device, a cellular telephone, a mobile telephone, a wireless telephone, a Personal Communication Systems (PCS) device, a PDA device which incorporates a wireless communication device, a smart phone, or the like. Embodiments may be used in various other apparatuses, devices, systems and/or networks.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
generating a platform signature for a software application executing on a platform that supports an isolated execution mode, the platform signature comprising a cryptographic hash of entity information associated with an entity having control of the software application, the entity information stored in persistent storage for the platform; and
providing the platform signature to the software application with the platform signature to attest that that the platform is associated with the software application.

2. The computer-implemented method of claim 1, comprising storing the entity information in persistent storage for the platform prior to generating the platform signature, the persistent storage comprising one or more internal fuses.

3. The computer-implemented method of claim 1, the entity information comprising one or more asymmetric security keys or cryptographic hashes of different asymmetric security keys for the entity.

4. The computer-implemented method of claim 1, the entity information comprising one or more symmetric security keys or cryptographic hashes of different symmetric security keys for the entity.

5. The computer-implemented method of claim 1, the entity information comprising an entity identifier or an entity name for the entity.

6. The computer-implemented method of claim 1, comprising compressing the entity information from a larger fixed length to a shorter fixed length using a cryptographic hash algorithm to produce the cryptographic hash.

7. The computer-implemented method of claim 1, comprising compressing the entity information from a variable length to a fixed length using a cryptographic hash algorithm to produce the cryptographic hash.

8. The computer-implemented method of claim 1, comprising generating the platform signature in response to an initial attest request received when the platform initially receives power.

9. The computer-implemented method of claim 1, comprising generating the platform signature in response to a recurring attest request received on a periodic basis.

10. The computer-implemented method of claim 1, comprising authenticating the platform when the platform signature of the platform matches a platform signature accessible to the software application.

11. An apparatus, comprising:
a platform comprising a processor capable of operating in an isolated execution mode and persistent storage, the persistent storage having entity information associated with an entity having control of a software application; and
a security controller communicatively coupled to the platform, the security controller having a signature generator operative to generate a platform signature for the software application executing on the platform, the platform signature comprising a cryptographic hash of entity information, and an attest module operative to provide the platform signature to the software application with the platform signature to attest that the platform is associated with the software application.

12. The apparatus of claim 11, the persistent storage including programmable internal fuses.

13. The apparatus of claim 11, the persistent storage arranged to receive the entity information, and store the entity information prior to generating the platform signature.

14. The apparatus of claim 11, the entity information comprising cryptographic information for the entity.

15. The apparatus of claim 11, the entity information comprising non-cryptographic information for the entity.

16. The apparatus of claim 10, comprising a digital display.

17. An article comprising a storage medium containing instructions that when executed enable a system to:
generate a platform signature for a software application executing on a platform that supports an isolated execution mode, the platform signature comprising a cryptographic hash of entity information associated with an entity having control of the software application stored in persistent storage for the platform; and
provide the platform signature to the software application with the platform signature to attest that that the platform is associated with the software application.

18. The article of claim 17, further comprising instructions that when executed enable the system to retrieve the entity information from persistent storage, the persistent storage having one or more internal fuses.

19. The article of claim 17, further comprising instructions that when executed enable the system to compress the entity information from a larger fixed length to a shorter fixed length using a cryptographic hash algorithm to produce the cryptographic hash.

20. The article of claim 17, further comprising instructions that when executed enable the system to compress the entity information from a variable length to a fixed length using a cryptographic hash algorithm to produce the cryptographic hash.
